(19) United States
(12) Patent Application Publication
(10) Pub. No.: US 2013/0211954 A1
(43) Pub. Date: Aug. 15, 2013

(54) METHOD FOR ENABLING A GIFT TRANSACTION

(71) Applicants: Lee Linden, San Francisco, CA (US); Benjamin Lewis, San Francisco, CA (US)

(72) Inventors: Lee Linden, San Francisco, CA (US); Benjamin Lewis, San Francisco, CA (US)

(21) Appl. No.: 13/615,307

(22) Filed: Sep. 13, 2012

Related U.S. Application Data
(60) Provisional application No. 61/534,336, filed on Sep. 13, 2011.

(51) Int. Cl. G06Q 30/06

(52) U.S. Cl. CPC G06Q 30/0633
USPC 705/26.8

(57) ABSTRACT

A method of an embodiment includes: accessing a list of gift items previously selected for a recipient by previous senders, the list comprising a first gift item previously selected by a first sender; receiving a gift request from a second sender, the gift request specifying the recipient and a second gift item; identifying a complementary relationship between the first gift item and the second gift item; requesting approval, from the recipient, of an aggregated gift item that is a combination of the first gift item and the second gift item; posting a notification of the aggregated gift item for publication by an online social network in response to approval of the aggregated gift item by the recipient; and initiating payment of the second gift item by the second sender in response to approval of the aggregated gift item by the recipient.

### CROSS-REFERENCE TO RELATED APPLICATIONS

This application claims the benefit of U.S. Provisional Application No. 61/534,336, filed 13 Sep. 2011, which is incorporated in its entirety by this reference.

### TECHNICAL FIELD

This invention relates generally to the field of electronic commerce (or ‘e-commerce’), and more specifically to a new and useful method for enabling a gift transaction via e-commerce.

### BACKGROUND

Online shopping accounts for a large percentage of purchases worldwide, and many of these purchases are for gifts, such as for friends or family members. Online gift shopping, however, can be tenuous for givers for multiple reasons. For example, a giver feels compelled to select the right options for the recipient, such as shirt size or cupcake flavor, because returns or exchanges of items in the absence of a brick-and-mortar store are typically difficult. The consumer must also enter a proper delivery address of the recipient, supply billing information, etc. without a great degree of confidence that the gift item will meet any need or interest of the recipient. Therefore there is a need for a new and useful method for enabling a gift transaction via e-commerce.

### BRIEF DESCRIPTION OF THE FIGURES

FIG. 1A is a flowchart representation of a method of an embodiment;

FIG. 1B is a flowchart representation of a variation of the method;

FIG. 2A is a flowchart representation of a second mechanism of the method;

FIG. 2B is a flowchart representation of a variation of the second mechanism of the method;

FIG. 3A is a flowchart representation of a third mechanism of the method;

FIG. 3B is a flowchart representation of a variation of the third mechanism of the method;

FIG. 4A is a flowchart representation of a fourth mechanism of the method;

FIG. 4B is a flowchart representation of a variation of the fourth mechanism of the method;

FIG. 5A is a flowchart representation of a fifth mechanism of the method;

FIG. 5B is a flowchart representation of a variation of the fifth mechanism of the method;

FIGS. 6A-6G are schematic representations of user interfaces in accordance with variations of the method; and

FIGS. 7A and 7B are schematic representations of user interfaces in accordance with variations of the method.

### DESCRIPTION OF THE EMBODIMENTS

The following description of the embodiments of the invention is not intended to limit the invention to these embodiments, but rather to enable any person skilled in the art to make and use this invention.

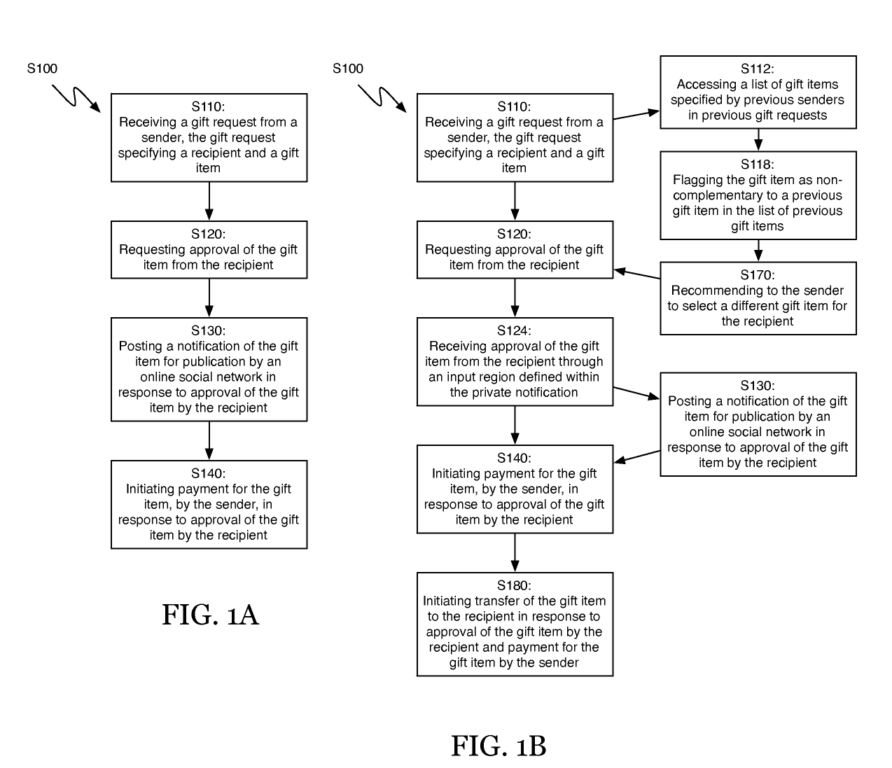

As shown in FIG. 1A, a method S100 for enabling a gift transaction, includes: receiving a gift request from a sender in Block S110, the gift request specifying a recipient and a gift item; requesting approval of the gift item from the recipient in Block S120; posting a notification of the gift item for publication by an online social network in response to approval of the gift item by the recipient in Block S130; and initiating payment for the gift item, on behalf of the sender, in response to approval of the gift item by the recipient in Block S140.

The method S100 enables a sender to select a gift (i.e. the gift item) for a recipient (e.g., one person, a group of people, an organization, etc.) and to virtually give the gift to the recipient prior to payment for the item. Once the recipient is notified of and approves the gift (privately), the method S100 posts a notification of the gift to a social network such that others users of the social network, such as friends and/or family of the sender and/or recipient, can see that the sender selected the gift item for the recipient. Once the recipient (virtually) approves the gift, the method S100 prompts the sender to pay for the gift, wherein social pressure of public knowledge of the gift selection can influence the sender to complete the gift transaction. Generally, the method S100 can enable impulse gifting by senders by delaying barriers to gifting, in particular, payment for the gift item. To ensure that the sender will not back out of the transaction, the method S100 can further persuade the sender into fulfilling the gift order by notifying the recipient of the intent of the sender to provide the gift to the recipient and posting a notification (e.g., a story, a timeline event) of the gift once approved by the recipient, both of which may elevate social pressure on the sender to complete the gift transaction. The notification can appear as a story in a newsfeed of another user (viewing user), where the viewing user is connected (e.g., direct connection, indirect connection) to the sender and/or the recipient. The notification can appear as a story in a timeline (e.g., collection of information about a single person, entity, etc.) of the sender and/or recipient. The timeline itself can be accessible to connections of the person or entity. The method S100 may therefore increase gifting activity of the sender by eliminating initial gifting steps that may otherwise dissuade completion of a gift order, such as extraneous steps that allot more time for the sender to second guess a purchase, reconsider the cost of the gift, to reconsider the appropriateness of the gift in light of his relationship with recipient, to contemplate needs or preferences of the recipient, or to gather and enter payment information. Generally, the method S100 does not obligate the sender to a legal contract or commitment to pay for the original or modified gift item, but rather can enable social pressures that may encourage the sender to fulfill the gift transaction previously specified by the sender. The method S100 may therefore enable less inhibited gift selection for senders without substantially compromising rates of gift conversion.

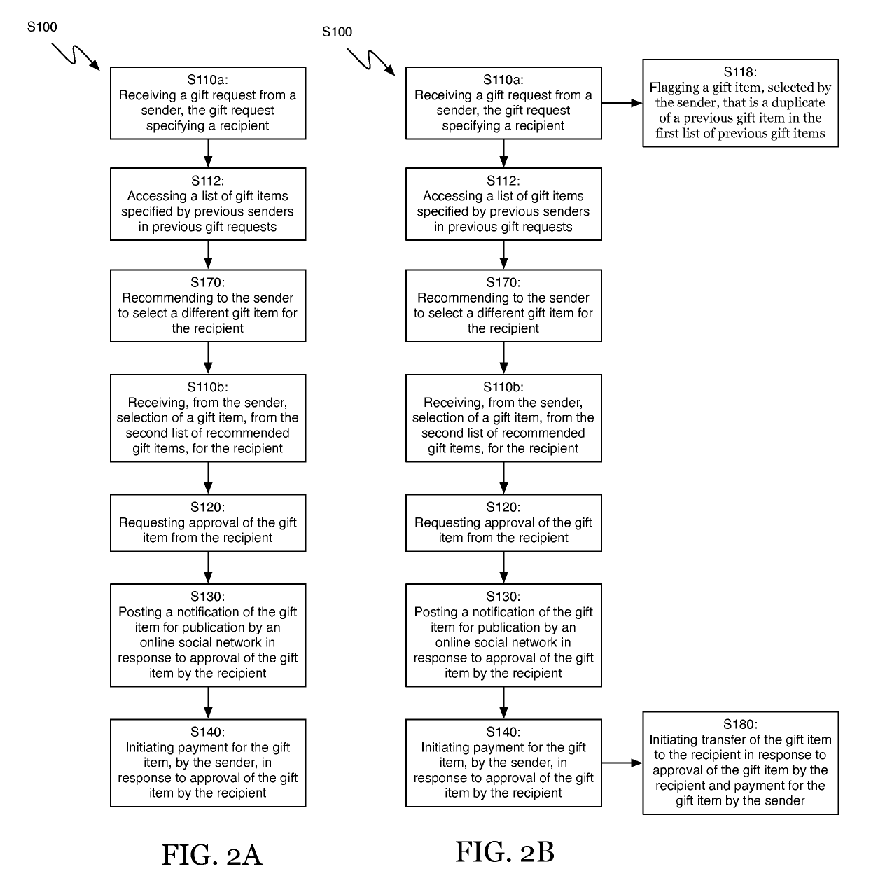

As shown in FIG. 2A, a variation of the method S100 is a second mechanism for preventing duplicate gift items from separate senders and includes: receiving a gift request from a sender in Block 110a, the gift request specifying a recipient; accessing a first list of gift items specified by previous senders in previous gift requests in Block S112; generating, for the sender, a second list of recommended gift items for the recipient and excluding gift items in the first list in Block S170; receiving, from the sender, selection of a gift item, from the second list of recommended gift items, for the recipient in Block S110b; requesting approval of the selected gift item from the recipient in Block S120; posting a notification of the selected gift item for publication by an online social network in response to approval of the selected gift item by the recipient in Block S130; and initiating payment for the gift item, on behalf of the sender, in response to approval of the selected gift item by the recipient in Block S140.

The variation of the method S100 that is the second mechanism additionally or alternatively assembles a first list of gifts previously selected by other senders for the recipient and makes gift selection recommendations to the sender based upon the list of previous gift items. Therefore, the second mechanism can prevent non-complementary and/or duplicate gift items selected for the recipient. In one implementation, the second mechanism generates a second list of gifts for the recipient based upon the first list of past gifts, wherein the sender is prompted to select a gift, from the second list, for the recipient. In another implementation, the second mechanism generates the first list of previous gift items, compares a gift selection by the sender to the first list, and, responsive to identification of the sender's selection as non-complementary to or a duplicate of a previous gift item in the first list, prompts the sender to select a different gift, such as from the second list of gift items. In one example, the second mechanism can generate gift item recommendations that exclude a case for a cellular phone, prior to gift selection by the sender, when a previous sender has already sent a cellular phone case to the recipient. In another example, the second mechanism can determine that a previous sender already sent a cellular phone case to the recipient, and, when the sender also selects a cellular phone case for the recipient, the second mechanism can recommend that the sender select a different gift for the recipient. Therefore, the second mechanism can make proactive or retroactive gift selection recommendations to the sender in light of gifts previously selected for the recipient by other senders.

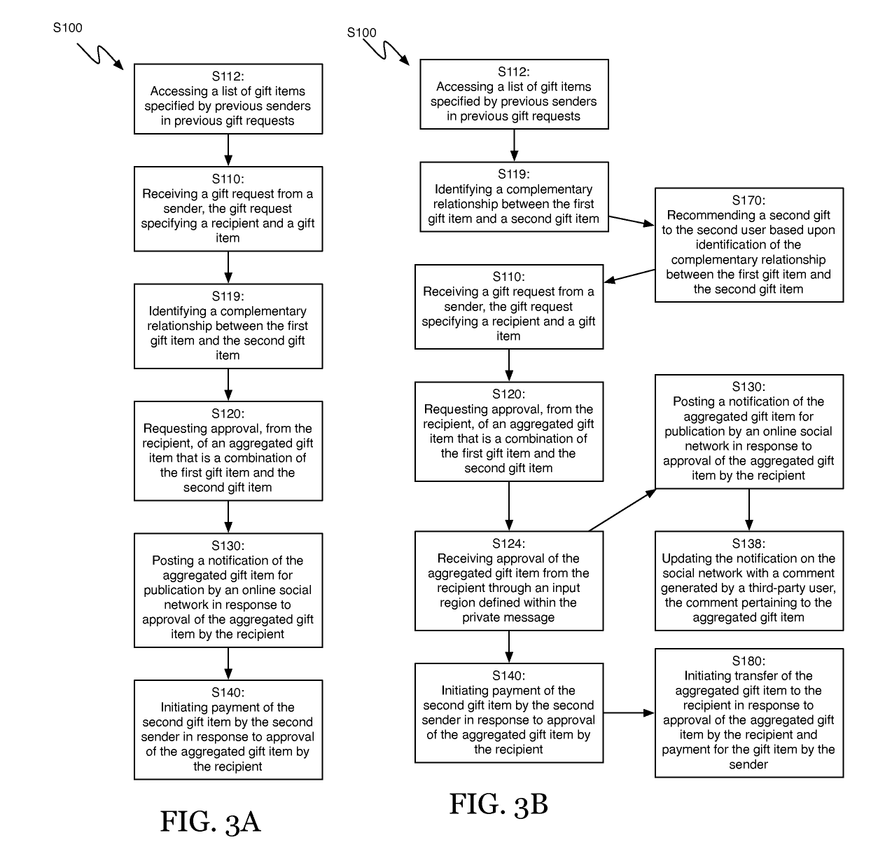

As shown in FIG. 3A, a variation of the method S100 is a third mechanism combining gift items from separate senders and includes: accessing a list of gift items previously selected for a recipient by previous senders in Block S112, the list comprising a first gift item previously selected by a first sender; receiving a gift request from a second sender, the gift request specifying the recipient and a second gift item in Block S110; identifying a complementary relationship between the first gift item and the second gift item in Block S119; requesting approval, from the recipient, of an aggregated gift item that is a combination of the first gift item and the second gift item in Block S120; posting a notification of the aggregated gift item for publication by an online social network in response to approval of the aggregated gift item by the recipient in Block S130; and initiating payment of the second gift item by the second sender in response to approval of the aggregated gift item by the recipient in Block S140.

The variation of the method S100 that is the third mechanism additionally or alternatively identifies similar and/or complementary gifts selected by the sender (the second sender) and by a previous sender (the first sender) such that the recipient can approve (and receive) the complementary gifts in aggregate. For example, the third mechanism can identify a second gift from the second sender that is a poker chip set as complementary to a first gift from the first sender that is a deck of cards. In this example, the third mechanism can notify the recipient of the aggregated poker set that is a combination of the first and second gifts, post the notification of the aggregated gift to the social network, and complete payment for at least the second gift by the second sender once the recipient approves the aggregated gift. The third mechanism can further initiate delivery of the (tangible) poker set to the recipient, such as through the mail. In another example, the third mechanism can identify the first gift that is a first subset of books in a book series and the second gift that is the remainder of books in a book series, combine the first and second gifts into the complete book series (the aggregated gift), notify the recipient of the complete book series intended as an aggregated gift from the first and second senders, and post the notification of the aggregated gift item once accepted by the recipient. Furthermore, similar to the second mechanism described above, the third mechanism can generate, for the second sender, a list of recommended gifts that are complementary to gifts previously selected by other senders. For example, the third mechanism can recommend that the second sender give a customized coffee mug to the recipient such that the coffee mug can be aggregated with a pound of coffee previously selected by the first sender. The third mechanism can also make recommendations for a complementary gift in response to identification of a duplicate and/or non-complementary gift selected by the second sender, such as described above.

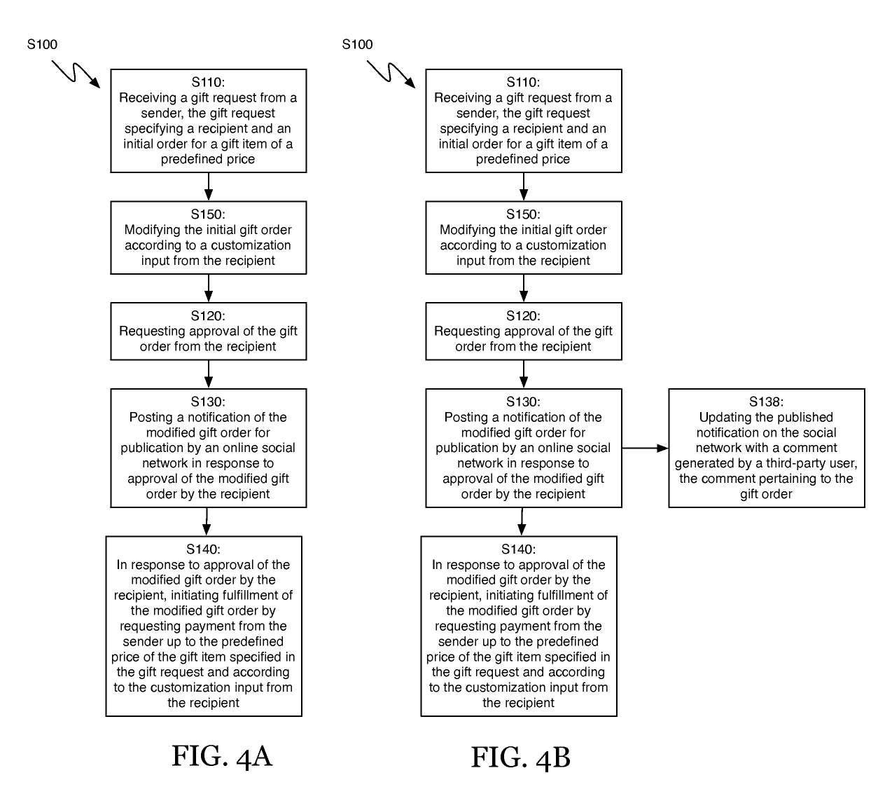

As shown in FIG. 4A, a variation of the method S100 is a fourth mechanism for enabling a gift adjustment by a recipient prior to purchase and includes: receiving a gift request from a sender in Block S110, the gift request specifying a recipient and an initial order for a gift item of a predefined price; modifying the initial gift order according to a customization input from the recipient in Block S150; requesting approval of the modified gift order from the recipient in Block S120; posting a notification of the modified gift order for publication by an online social network in response to approval of the modified gift order by the recipient in Block S130; and, in response to approval of the modified gift order by the recipient, initiating fulfillment of the modified gift order by requesting payment from the sender up to the predefined price of the gift item specified in the gift request and according to the customization input from the recipient in Block S140.

The variation of the method S100 that is the fourth mechanism additionally or alternatively provides a venue through which the recipient can modify, (e.g., exchange, customize, and/or personalize) a gift order prior to fulfillment of the gift order (i.e. prior to payment for gift by the sender). Generally, the fourth mechanism automatically generates a notification of the gift for the recipient once the sender selects the gift, directs the recipient to modify the gift, and only posts the notification for the gift and initiates payment for the gift once details of the gift achieve suitable satisfaction of the recipient, as indicated by approval of the gift by the recipient. For example, the recipient can opt to exchange the gift for a monetary donation to a preferred charity, to select a different color for the gift item, to select a different size for the gift item, or to add a personal engraving to the gift item.

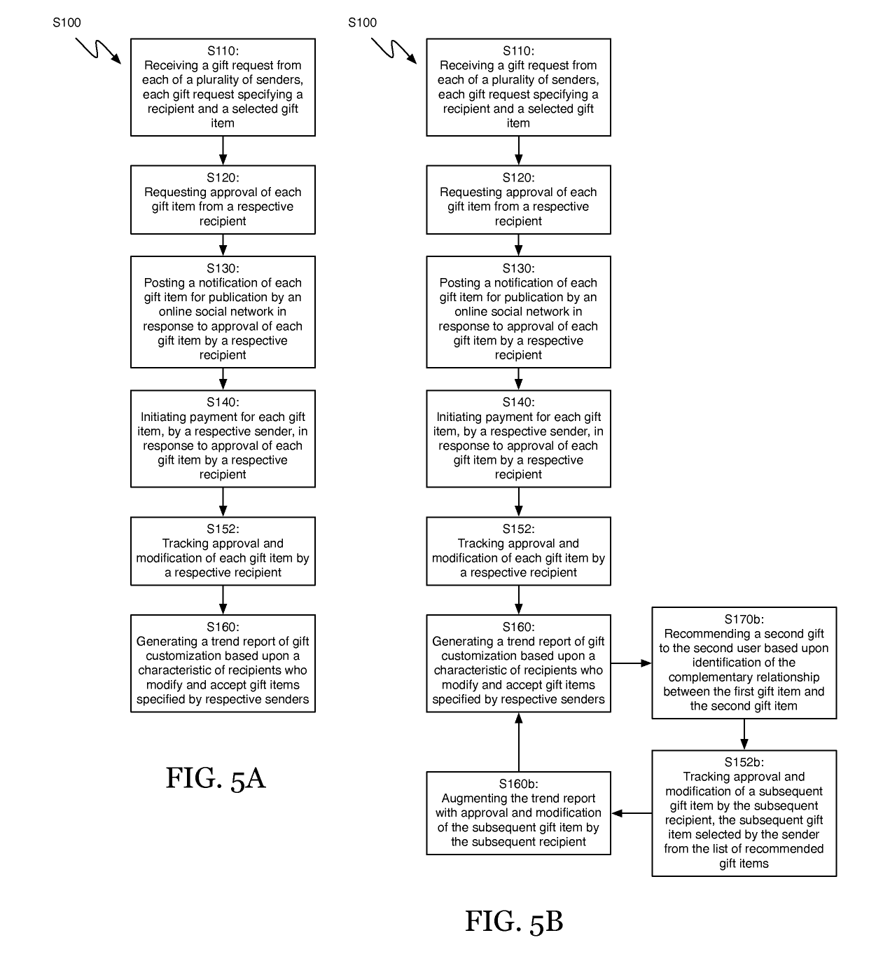

As shown in FIG. 5A, a variation of the method S100 is a fifth mechanism for tracking gift approval of recipients and includes: receiving a gift request from each of a plurality of senders in Block S110, each gift request specifying a recipient and a selected gift item; requesting approval of each gift item from a respective recipient in Block S120; posting a notification of each gift item for publication by an online social network in response to approval of each gift item by a respective recipient in Block S130; initiating payment for each gift item, by a respective sender, in response to approval of each gift item by a respective recipient in Block S140; tracking approval and modification of each gift item by a respective recipient in Block S152; and generating a trend report of gift customization based upon a characteristic of the recipients who modify and accept gift items specified by respective senders in Block S160.

The variation of the method S100 that is the fifth mechanism additionally or alternatively collects data pertaining to recipient approval, modification, customization, and/or personalization of gifts selected by senders. The fifth mechanism can analyze this data to isolate trends in recipient responses to gift items, such as based upon demographics, relationships, gift history, or recipient interests or personality traits. For example, the fifth mechanism can identify high degrees of customization by recipients between the ages of eight and nineteen years, low degrees of customization by male recipients over forty years of age, high rates of gift conversion to charitable donations by female recipients between the ages of twenty-five and thirty-five, high rates of software and/or hardware upgrades for technology gifts by male recipients indicating interest in technology, and low rates of customization by recipients of gifts from close friends. The fifth mechanism can therefore generate trend reports that can inform gift recommendations for a particular sender intending to send a gift to a particular recipient of a particular demographic, relationship with the sender, interest, gift history, etc. Gift recommendations informed through the trend reports can thus enable a sender to select a gift that better fulfills the anticipated needs and/or wants of a recipient, which may increase likelihood approval of the gift by the particular recipient and therefore increase net gift purchases for a respective sender.

The method S100 is can be implemented by a computer system as a gifting service that collects sender gift requests in Block S110, requests gift approval by recipients in Block S120, posts notifications of approved gift selections in Block S130, and triggers payments for approved gifts, by senders, in Block S140. The computer system can be cloud-based (e.g., Amazon EC3), a mainframe computer system, a grid-computer system, or any other suitable computer system. Gift requests and gift approvals can be collected by the computer system over the computer network, such as via the Internet. The computer system includes one or more processors configured to receive gift selections and gift approvals, to generate gift notifications, and to control payment and delivery of gift items.

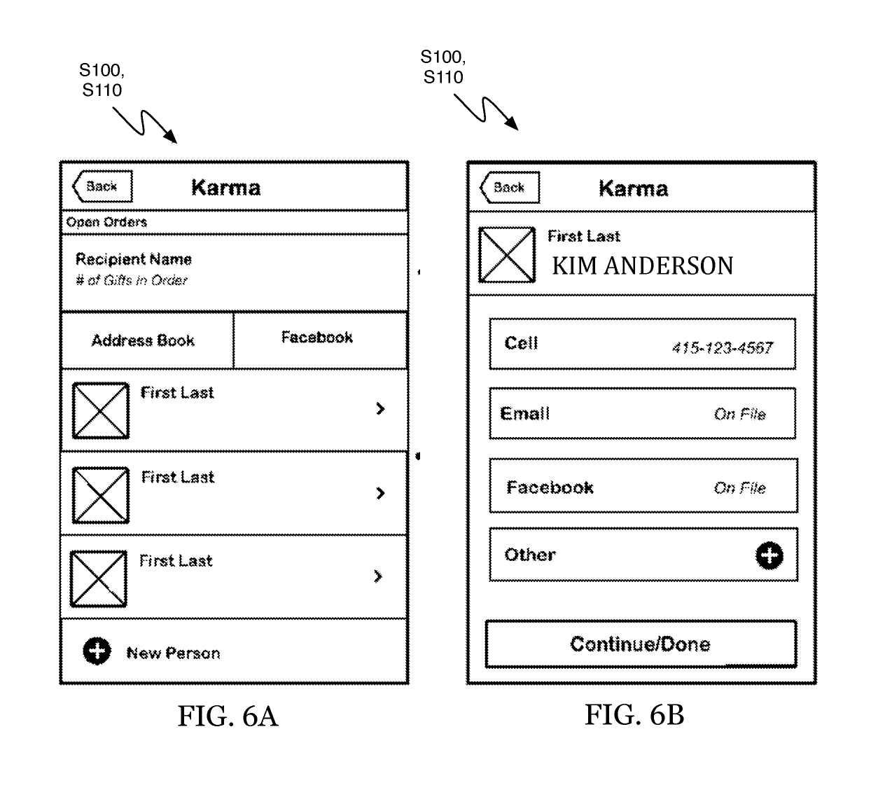

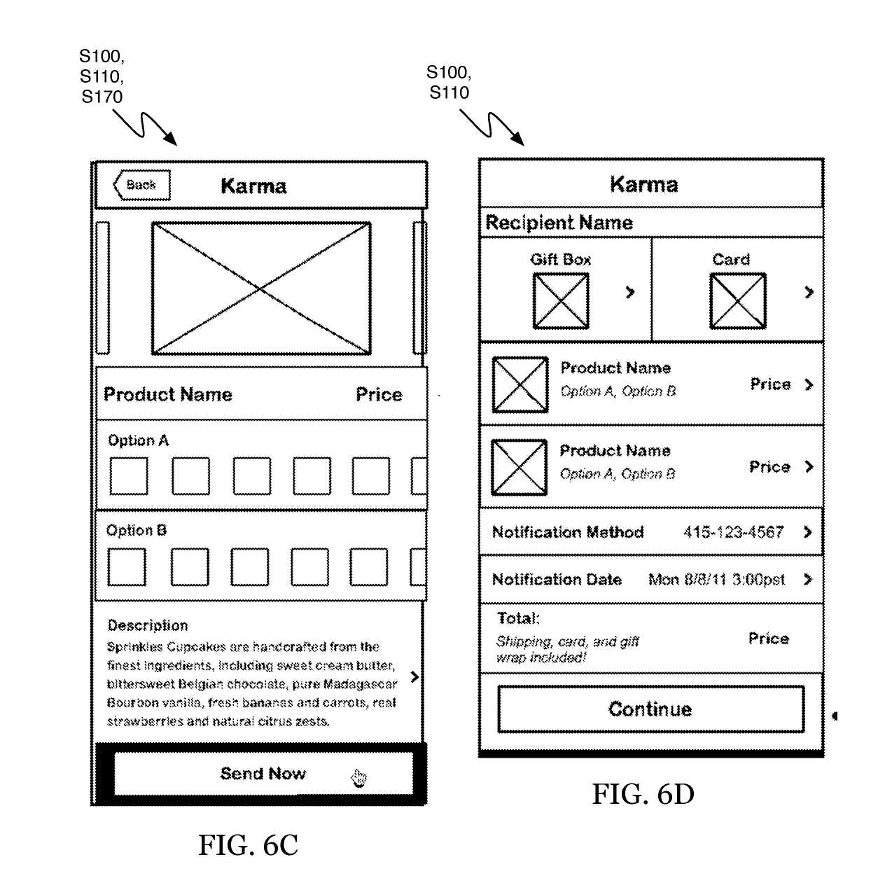

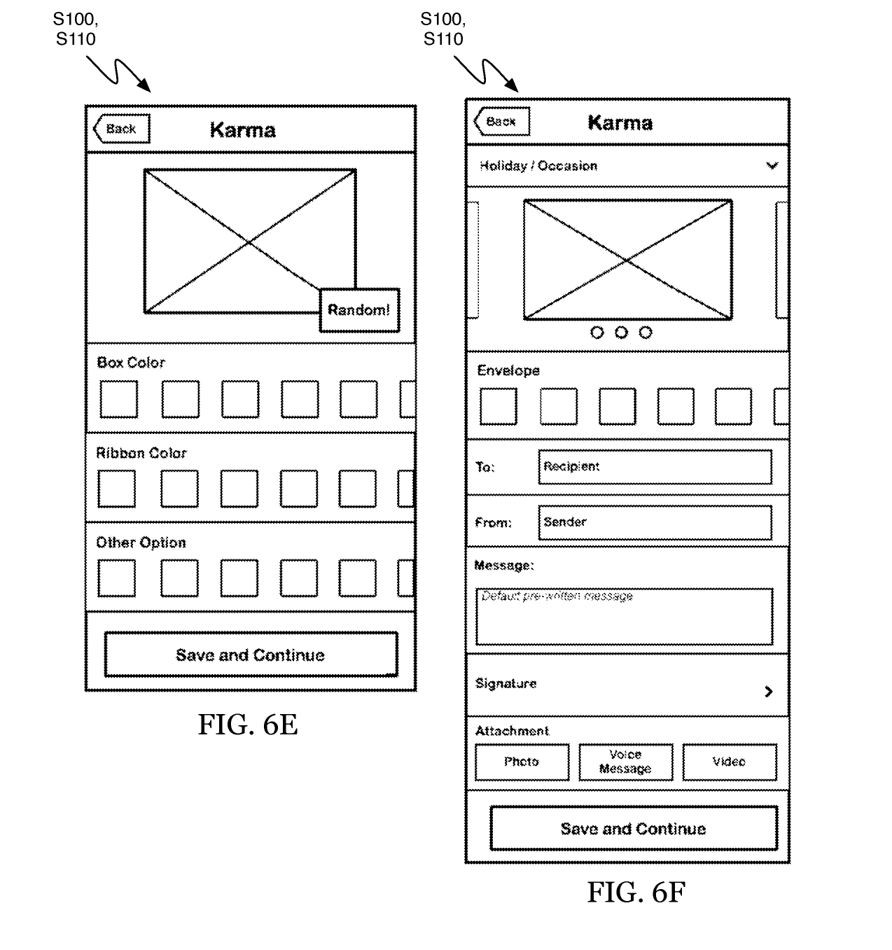

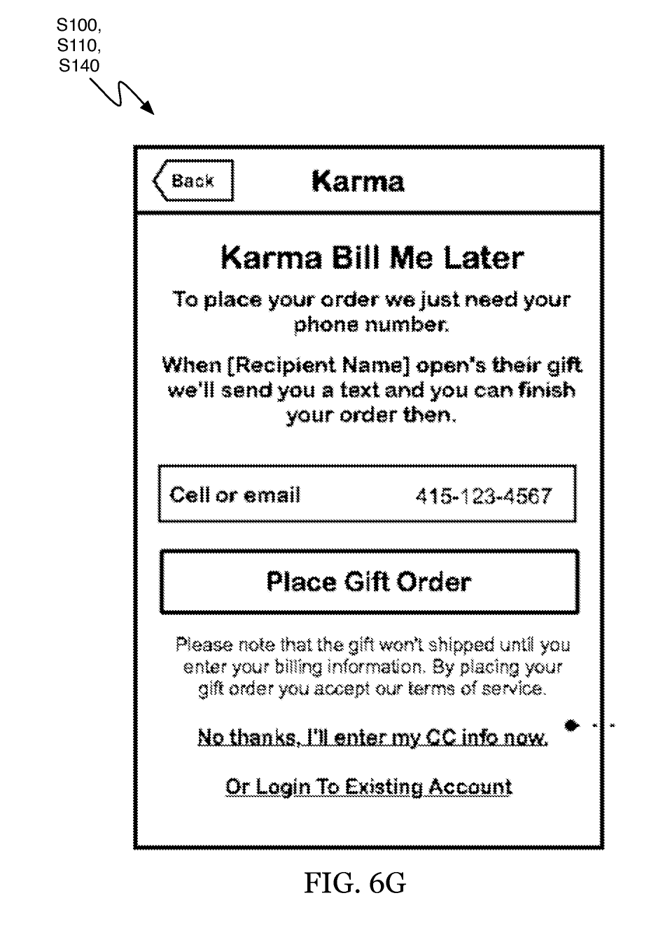

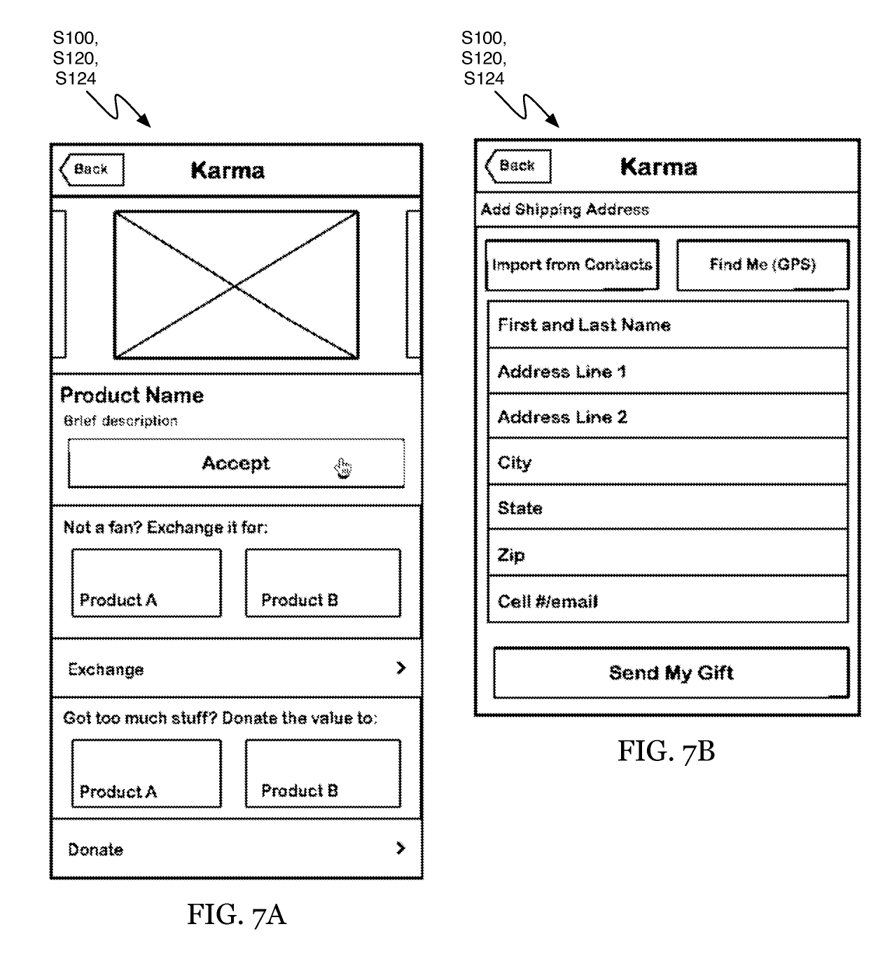

The computer system can incorporate a sender-side interface (or ‘dashboard’) and a recipient-side interface. The sender-side interface can be accessible by a sender to generate a gift request, review recommended gift items, define gift delivery preferences, provide payment information, etc., as shown in FIGS. 6A-6G. The recipient-side interface can be accessible by the recipient to approve, modify, exchange, customize, personalize, combine, and/or separate one or more gifts, etc., as shown in FIG. 7A. Generally, the sender- and recipient-side interfaces can each be accessible through a web browser or native application executing on an electronic device, such as a laptop computer, a desktop computer, a tablet, a smartphone, a personal data assistant (PDA), a personal music player, etc.

The method S100 can be implemented through an online social network that enables communication between users (e.g., potential senders and recipients), contains relevant sender and/or receiver information, (e.g., sender-receiver relationship status, sender and/or receiver demographic information, sender and/or receiver interests), tracks dates and/or occurrences of gift-appropriate events (e.g., birthdays, promotions, graduations, anniversaries), and tracks tangible and/or virtual gifts sent to the recipient by other senders. Additionally or alternatively, the method S100 can be implemented by an online dating network, a single-merchant online marketplace, an online merchant aggregator, or any other suitable online or brick-and-mortar venue that enables remote exchange of goods and/or services. However, the method S100 can be implemented by any other entity or through any other computer system, and the method S100 can implement any other interface(s) to send or and receive gift- or user-related data to or from the senders or recipients.

Block S110 of the method S100 recites receiving a gift request from a sender, wherein the gift request specifies a recipient and a gift item. Block S110 can capture the sender's selection of the recipient through a single unique identifier of the gift recipient, such as a mobile phone number, an email address, a social networking username, or any other suitable identifier. However, Block S110 can capture the sender's selection of the recipient by combining multiple identifiers of the gift recipient.

The sender can enter the gift request through the sender-side interface as described above. For example, the sender can use a smartphone to access a personal online social networking profile (the ‘sender-side interface’), select the recipient from a list of connections (e.g., friends, friends of friends, acquaintances, etc.) linked to the sender's node or profile as shown in FIGS. 6A and 6B, open a list of available gifts items as shown in FIG. 6C, and, from this list, select a gift item for the recipient as shown in FIG. 6D. In another example, the sender can use a desktop computer to browse through an online shopping site, find an item he deems appropriate as a gift for a friend (the ‘recipient’), and select a “GIFT” button on the same page (e.g., adjacent “FACEBOOK,” “TWITTER,” and “PINTEREST” icons), wherein the method S100 opens the sender-side interface and prompts the sender to identity the friend from a list of contacts of the sender sourced from an online social networking profile of the sender. In yet another example, the sender can shop in brick-and-mortar store, identify an item he deems appropriate as a gift for a friend (the ‘recipient’), select the gift for the recipient by capturing an ISBN, SKU number, barcode, etc. of the item through a camera on a cellular phone implementing machine vision, and complete the gift request by selecting the recipient through a digital contact book on the cellular phone. However, the sender can specify any one or more details of the gift request in any other way.

Furthermore, in other variations of the method S100, such as the second mechanism, the gift request can specify only a recipient and intent of the sender to send a gift to the recipient, such as a gift item subsequently selected by the sender from a list of gift items generated in Block S170. Block S110 can identify the recipient of the gift item

By selecting the gift item, such as shown in FIG. 6G, the sender can indicate intent to pay for the item in the future, such as once the gift item is approved by the recipient. Similarly, by selecting the gift item, the sender can indicate intent to pay for the modified gift item up to the original specified value of the gift item once modified and approved by the recipient. Additionally or alternatively, by selecting the gift item, the sender can indicate intent to pay for a different item or donation up to the original specified value of the gift item once modified and approved by the recipient. The method S100 therefore can enable social pressures that may coerce the recipient into fulfilling an order for the original or modified gift item only up to the specified value of the original gift item selected by the sender, regardless of the final price of the gift item after modification or exchange by the recipient.

Block S110 can further include receiving the gift request that specifies additional gift details. In one example, the sender can specify intent to pay for gift personalization, by the recipient, up to 10% over of the original price of the item. Alternatively, the sender can specify that only 80% of the original price of the gift item (e.g., a book) can be applied to an item in a different category (e.g., a video game). The sender can also specify limitations to gift modifications or exchanges, such as excluding exchange of dinner for two for a dress or excluding exchange of a houseplant for a case of beer. The sender can also specify, within the gift request, a preferred payment method and/or provide payment information, such as a credit card number or non-monetary points or credits within on online community or network. The computer system can store this payment information and accesses the payment information to pay for the gift item once approved by the recipient. Therefore, Block S110 can therefore include receiving the gift request, from the sender, that specifies how the gift item can be modified or exchanged, how much or what gift modifications the sender is willing to pay for, how the sender will pay for the gift item, limits or boundaries to gift modifications acceptable to the sender, etc. As shown in FIG. 6D, the sender can also select a ‘backup’ or secondary gift item for the recipient as an option for the recipient who does not prefer the first gift item. However, the gift request can include any other suitable information.

As in the method S100 and the fourth and fifth mechanisms, the gift request can be assembled from substantially unsupervised (e.g., uninterrupted) sender input. Alternatively, as in the second mechanism and shown in FIG. 2B, the gift request can be assembled from an initial recipient selection by the sender in Block S110a and a subsequent supervised gift selection in Block S110b. For example, the sender can be prompted to select the gift item from a list of suitable gift items for the recipient, such as the second list generated in Block S170. In another example, such as in the third mechanism, once the sender selects the recipient, the method S100 can share with the sender a list of gift items already selected for the recipient by other senders, which can guide the sender in selecting a non-duplicate or a complementary gift item for the recipient. However, the gift request can be assembled, supervised, or received in any other way.

Therefore, as in the second mechanism and shown in FIGS. 1B and 2A, a variation of the method S100 can further include Block S112, which recites accessing a first list of gift items specified by other senders in previous gift requests. Block S112 can be triggered once the sender selects the recipient, such as by selecting a social networking account of the recipient or entering an email address or phone number linked to the recipient, though the sender can identify the recipient in any other way. Once the recipient is identified, Block S112 can gather the first list of gifts selected for and/or sent to the recipient, by other senders, within a specified time window. For example, Block S112 can assemble the first list of previous gift items selected for the recipient within the last three hours, within the last day, or within the last week. In one implementation, Block S112 selects the time window based upon the nature of the event that provoked the sender to select a gift to the recipient. For example, Block S112 can select the time window that is a week for the recipient who has recently or will soon graduate from college, that is a day for the recipient who recently had or who will soon have a birthday, or that is three hours for the recipient who was recently promoted at work. Therefore, Block S112 can further include identifying the nature of gift giving by the sender and/or the other senders. For example, Block S112 can include mining comments on a social networking profile of the recipient for cues to the nature of recent gift giving, such as the phrases “Happy Birthday,” “Congratulations,” or “It's a boy!” Block S112 can therefore identify intention of the sender to send a gift to the recipient as a birthday gift, a congratulatory gift, a thank you gift, a wedding present, a spontaneous gift, etc., which can further inform generation of the second list of (suitable) gifts for the recipient in Block S170. Additionally or alternatively, the sender can set the time window or the time window can be constant or predefined.

Block S112 can access the first list of gifts previously selected for the recipient through the gifting service that implements the method S100. However, Block S112 can access gift information, pertaining to the recipient, from external services or computer systems used by other senders to send gifts to the recipient. For example, Block S112 can aggregate gift items sent to the recipient through a marketplace within an online social network, through a standalone online marketplace for a single merchant, through an online merchant aggregator, through gift applications implemented within a brick-and-mortar retailer, etc. to create a substantially comprehensive first list of previous gift items selected for the recipient by other senders. In another example, Block S112 can access a wedding registry to determine which gift items, specified by the recipient, have already been selected for the recipient by other senders. However, Block S112 can generate the first list of previous gift items selected for the recipient in any other way.

As in the second mechanism and shown in FIGS. 1B and 2B, a variation of the method S100 can further include Block S118, which recites flagging the gift item, selected by the sender, as non-complementary to a previous gift item in the list of previous gift items. Block S118 therefore can identify the sender's gift selection as a duplicate of and/or non-complementary to previous gift items selected by other senders by comparing the sender's gift item selection with previous gift item selections of other senders. For example, Block S118 can flag the sender's gift selection for an electric drill if another sender previously also selected an electric drill. Similarly, Block S118 can flag the sender's gift selection for a tea cup set if another sender previously selected a full dishware set (e.g., cups, plates, bowls, tea cups, saucers, etc.). In a further example, Block S118 can flag the sender's gift selection for dinner for two at a particular restaurant if another sender previously selected lunch for two at the same restaurant. As described below, Block S170 can recommend an alternative gift item to the sender when Block S118 identifies a duplicate or non-complementary gift item selection by the sender.

Block S118 can additionally or alternatively flag a gift item selection, by the sender, that substantially contrasts with gift preferences or gift settings associated with the recipient. In one example, a parent can set gift preferences for a child (the ‘recipient’) that restrict the number of video games gifted to the child to no more than two games per month. In this example, Block S118 can flag a video game, selected by the sender, when two other senders each previously gifted a video game to the recipient within a month of the sender's gift selection. In another example, the recipient can select a gift preference that excludes liquor products, and Block S118 can flag a gift, selected by the sender, for a bottle of wine. In this variation, Block S118 can access gift preferences of the recipient from an online social network profile of the recipient, such as based upon privacy settings set by the recipient. However, Block S118 can access gift preferences or gift settings associated with the recipient in any other way. Generally, flagged gift item selections can trigger a recommendation to the sender to select a different gift item for the recipient, such as a gift item from a gift of list items generated in Block S170.

Similarly, as in the third mechanism and shown in FIGS. 3A and 3B, a variation of the method S100 can further include Block S119, which recites identifying a complimentary relationship between the sender's gift item (the ‘second gift item’) and a previous sender's gift item (the ‘first gift item’). Generally, Block S119 can include identifying a complementary use scenario for the first gift item and a previous gift item by comparing the first gift item selected by the sender with a previous gift item selected for the recipient by a previous sender. For example, Block S119 can determine that the sender's selection of a blue sunhat (an accessory) is complementary to a blue sundress (apparel) selected for the recipient by a previous sender. Therefore, as in this example, Block S119 can identify different but complimentary items based upon the categories, types, and/or attributes of the compared gift items. In another example, Block S119 can determine a bottle of whiskey selected by the sender to be supportive of a set of rocks glasses selected by a previous sender. Furthermore, Block S119 can identify complementary gift items according to predefined rules. For example, a rule can specify that if a first gift is apparel that is any of {a sundress, shorts, or tank top}, and if the second gift is an accessory that is any of {sunglasses or a sunhat}, then the first and second gifts are complementary. Block S119 therefore can compare previous gift items with unsupervised sender gift selections, though Block S119 can additionally or alternatively compare previous gift items with a sender gift selection from a list of suitable gift items presented to the user, such as in the second mechanism in which the sender selects a gift item from the second list of gift items generated in Block S170. However, Block S119 can function in any other way to identify a complimentary relationship between the sender's gift item and a previous gift item.

Blocks S118 and/or S119 can identify duplicate and/or non-complementary gift items at any one or more suitable levels of comparison. For example, Blocks S118 and/or S119 can identify two gift items that are smartphone cases of the same color as duplicates but identify two gift items that are smartphone cases of different colors as not duplicates because, even though the smartphone cases differ only in color, a recipient may have an interest in color-coordinating smartphone cases with outfits. In another example, Block S118 can identify two gift items that are slippers of different materials and configurations as duplicates because a recipient will likely never need more than a single pair of slippers at any one time. In yet another example, Blocks S118 and/or S119 can identify two gift items that are two gift certificates of the same amount and for the same retailer as complementary (though also duplicates) because a recipient can effectively utilize both gift certificates at the same time. Therefore Block S118 can compare gift attributes, gift categories, gift use scenarios, gift usage requirements, actual or estimated recipient interests, actual or estimated recipient needs, or any other suitable factor or level of comparison to identify duplicate and/or complementary gift items for a recipient. Additionally or alternatively, Block S119 can implement similar comparisons to identify complimentary gift items for a recipient.

As in the second, third, and fifth mechanism and shown in FIGS. 2A, 3B, and 4B, a variation of the method S100 can further include Block S170, which recites generating, for the sender, a (second) list of recommended gift items for the recipient and excluding gift items in a (first) list of previous gift items selected by previous senders. In one example implementation, contingent upon privacy settings set by the recipient, Block S170 accesses recipient interests entered into a social networking profile of the recipient, identifies items of potential interest and/or use to the recipient based thereupon, and generates the second list that excludes the gift items from the first list, such as the first list generated in Block S112. In another implementation, Block S170 accesses one or more wishlists maintained by the user across one or more online marketplaces or vendors and generates the second list by aggregating the wishlists exclusive of items in the first list. Similarly, Block S170 can access a current or past wedding registry of the recipient to generate the second list. Contingent upon privacy settings set by the recipient, Block S170 can additionally or alternatively access purchase records of the recipient, such as through data collected from an online marketplace or a credit card history of the recipient, and, from this data, generate the second list that includes items complementary to past recipient purchases and/or in line with recipient needs and/or interests gleaned from past recipient purchases. Also contingent upon privacy settings set by the recipient, Block S170 can analyze recipient online browsing history (e.g., through recipient browser cookies) to identify items of interest to the user and, from these items of interest, generate the second list. In yet another example implementation, because previous senders may have a suitable understanding of the needs and/or interests of the recipient, Block S170 identifies gift items complementary to gift items in the first list and aggregates the complementary items into the second list. Block S170 can additionally or alternatively identify interests, preferences, and/or needs of the recipient by analyzing previous gift modifications or customizations made by the recipient and, from this extracted data, generate the second list. For example, Block S170 can manipulate a trend report generated via the fifth mechanism to generate the second list of recommended gift items. Similarly, Block S170 can estimate interests and/or needs of the recipient by correlating the recipient with a recipient test group with known needs and/or interests, such as based upon recipient demographics (e.g., age, gender, location, race, etc.). From these determined needs and/or interests of the recipient, Block S170 can generate the second list.

Additionally or alternatively, Block S170 can generate the second list of gift items that substantially parallel interests or preferences of the sender. In several example implementations, Block S170 can generate the second list that includes gift items within a preferred price range specified by the sender, within a range of percentages of the original value of a gift item selected by the sender, estimated based upon a previous gift selection or past purchase of the sender, or estimates based upon characteristics or demographics of other senders similar that are similar to characteristics or demographics of the sender. For example, Block S170 can generate the second list that includes books but excludes movies for the sender (and not the recipient) who indicates a preference for reading. However, Block S170 can function in any other way to generate the second list of suitable gift items for the recipient, the second list exclusive of the first list of previous gift items.

As shown in FIG. 1, Block S120 of the method S100 recites requesting approval of the gift item from the recipient. Recipient notification of the gift item can be private in Block S120 and can be triggered by completion of the gift request by the sender. Block S120 includes can push a private message of the gift item to the recipient through the online social network. For example, Block S120 can generate a private message for the recipient within a social networking profile associated with the recipient. Alternatively, Block S120 can transmit a SMS text message, native application pop-up, an email, or any other suitable type of message of (private) notification to an account, profile, mobile electronic device, or other electronic device or application linked to, associated with, or accessible to the recipient. When accessed by the recipient, the private message can direct the recipient to the recipient-side interface through which the recipient can approve, modify, customize, personalize, exchange, return, or otherwise respond to the gift selection by the sender. As described above, Block S120 can push the message of the gift item to the recipient according to a delivery preference set by the sender.

Block S120 therefore can include generating an electronic message of the gift item for the recipient. Block S120 can generate the message that identifies both the sender and the gift selection, as shown in FIG. 7A. For example, Block S120 can generate the message that includes the name of the sender, a stock or sender-generated picture of the gift item, and a short description of the item in the message. The message can further define an input region that prompts the recipient to approve the selected gift item. As in the third mechanism, the message can also prompt the recipient to approve an aggregated gift item that includes the gift item in combination with a previous gift item selected by a previous sender and/or previously approved by the recipient. The message can further include an input region that prompts the recipient to modify or customize the gift item and/or input region that prompts the user to decline the gift item, as shown in FIG. 7A. For example, Block S120 can generate the message that includes “Scott H. has sent you a bottle of 2007 Cabernet Franc from Screeching Eagle in Napa Valley, Calif. Click HERE to approve this gift, and we'll also recommend when to open it and how to drink it. Alternatively, you can select a different wine from this winery by clicking HERE, or ignore this gift and we'll return it to the sender.” In this example, the message for the recipient include multiple input regions that the recipient can engage to accept or modify the gift item, as well as directions to decline the gift item from the sender.

In one variation of the method S100, Block S110 includes receiving the gift request that includes sender selection of a (virtual) gift card (shown in FIG. 6F) and/or gift box (shown in FIG. 6E) for the gift. For example, the sender can select a style, color, and/or size of a virtual gift box, as well as the color of virtual ribbon on the gift box. As shown in FIG. 6E, the style, color, size, and/or ribbon of a virtual gift box can be selected randomly, such as prior to selection of such details by the sender. The gift sender can also select and digitally sign a virtual gift card, as well as inputting a custom message into the custom card. For example, if the sender generates the gift request through a touchscreen mobile device (e.g., a tablet), the sender can add a signature to the gift card by tracing a finger across the screen of the mobile device. The gift card can include a default message that is overridden by the sender's custom message, and the sender can further add a photo, video, or sound attachment to the gift card. In this variation, Block S120 can transmit a form of the gift card and/or gift box to the recipient to notify the recipient of the gift item selected by the sender.

Block S120 can further enable the recipient to digitally unwrap the gift box to fulfill a gift experience for the recipient. For example, Block S120 can transmit an electronic message to a smartphone carried by recipient, wherein the electronic message includes the heading “Scott. H. has sent you a birthday present. Peel away the wrapping to see what it is!” In this example, the touchscreen can display the message and an image of a wrapped box, wherein the recipient can pinch, twist, stretch, drag, or input any other gesture into the touchscreen to virtually peel the wrapping off of the box. Once completed, the smartphone can visually render an image and/or description of the gift item or otherwise virtually reveal the gift selection to the recipient. In this example, the recipient can indicate approval of the gift by digitally unwrapping the gift or be selecting an “APPROVE” input region displayed on the touchscreen. However, Block S120 can generate the message that simulates an gift opening experience, includes any other gift-related information, and/or defines any other input region to receive any other type of input from the recipient. The method S100 can therefore receive recipient approval of the gift item through an input region defined within the message, as in Block S124. The method S100 can similarly initiate modification of the gift item by the recipient through the message.

Alternatively, Block S120 can generate the private message for the recipient, and the private message can be configured to be viewed by the recipient on an electronic device, such as from within a browser or application executing on a smartphone. Block S120 can deliver the message to the recipient based upon a delivery time, date, and/or method specified by the sender in the gift request, as shown in FIG. 6D. For example, the sender can input the gift request two days before the recipient's birthday and set the message of the gift item to be delivered to the recipient via SMS message at 8 am on the day of the recipient's birthday. Alternatively, Block S120 can transmit the private message to the recipient immediately following completion of the gift request, according to a default time, or according to any other schema.

One variation of the method S100 further includes Block S124, which recites receiving approval of the gift item from the recipient through an input region defined within the private message. Generally, Block 5124 can capture recipient selection of an “APPROVE” input region within the message and/or within the recipient-side interface, such as shown in FIG. 7A. However, Blocks S120 and/or S124 can function in any other way to generate the electronic message of the gift, push the electronic message of the gift to the recipient, and capture recipient approval of the gift.

As shown in FIG. 1A, Block S130 of the method S100 recites posting a notification of the gift item for publication by the online social network in response to approval of the gift item by the recipient. Once the recipient approves the gift item, Block S130 can publicize the gift request, according to privacy settings selected by the recipient and/or by the sender, such that the gift request can be viewed by other users, such as friends and/or family of the sender and/or recipient. Therefore, Block S130 can function to generate social pressure for the sender to fulfill the gift order for the recipient that may result from public knowledge of the gift selection by the sender. Block Si3o can post the notification of the gift item to an online social networking profile associated with the recipient such that the details of the gift selection are accessible to third-party users of the social network. Additionally or alternatively, Block S130 can post a notification of the gift item to an online social networking profile associated with the sender such that the gift details are accessible to third-party users of the social network. The third-party users can be friends of, connections to, within a social circle of, or otherwise associated with the recipient (and/or the sender) within the social network. Furthermore, access to the notification by other users can be set according to privacy settings selected by the recipient and/or by the sender.

Block S130 can generate the notification that specifies the recipient, the sender, and the final gift item selected by the recipient. For example, a first published notification that states “Jesse E. just approved a bottle of 2007 Cabernet Franc from Scott H.” can be posted to Jesse E.'s social networking profile, and a second published notification that states “Scott H. just selected a bottle of 2007 Cabernet Franc for Jesse E.” can be posted to Scott H.'s social networking profile, wherein the first notification is only accessible to Jesse E.'s connections, and wherein the second notification is only accessible to Scot H.'s. Additionally or alternatively, the notification can include the initial gift order, the initial gift order and a modification to the gift order by the recipient, or any other suitable gift-related information.

To post the notification, Block S130 can generate a notification that is subsequently published by the online social network. To post the notification, Block S130 can also transmit the notification to the social network, or Block S130 can transmit key details of the gift transaction to the social network, wherein the social network generates and publishes the notification based upon the received details of the gift transaction. However, Block S130 can function in any other way and/or cooperate with any other entity to generate, post, and publish the notification to the online social network.

A variation of the method S100 further includes Block S138, which recites updating a posting of a notification published by the social network with a comment generated by a third-party user. Comments provided by third-party users in reference to the notification may include text or images supportive of the gift selection by the sender, gift modification by the recipient, additional notifications generated via the method S100 in response to approval of additional gift items selected by other senders, or any other message pertaining to the gift order or the event that provoked gift selection, by the sender, for the recipient. The comments may also include a recommendation, by a third-party user, to modify the gift order, wherein, if the order has not yet been completed by the sender, Block S130 can push the recommendation to the recipient and enable the recipient to adjust the gift item according to the recommendation from the third-party user. However, Block S130 can function in any other way to publicize the gift order and/or to manage third-party user comments related to the gift order.

As shown in FIG. 1, Block S140 of the method S100 recites initiating payment for the gift item, on behalf of the sender, in response to approval of the gift item by the recipient. Once the recipient approves the gift item, Block S140 can automatically initiate fulfillment of the gift order by authorizing payment for the gift item via a financial account provided by the sender and/or by (directly) applying payment information, provided by the sender, to an order for the gift item. Block S140 can include transmitting, to the sender, a private message of recipient approval of the gift item, wherein the private message prompts the sender to supply payment information. For example, Block S130 can transmit an email, SMS text message, MMS message, social network message, sender-side interface alert or message, native application pop-up message to the sender, or any other suitable type or form of communication to prompt the user to furnish a payment option. The private message therefore can further include a payment input region that prompts the sender to link or identify a financial account or asset, such as personal credit card information, a debit card, a checking account, a gift card, or any other digital or virtual form of payment.

Block S140 can transmit the private message to the sender that also identifies a form of social persuasion, social pressure, and/or encouragement for the sender. In an example implementation, Block S140 generates the private message that states that the gift request has been posted to the social network such that friends, family, etc. of the sender can access the gift request.

In another example implementation, Block S140 generates the private message that includes a comment posted to the social network, by a third-party user, in response to the notification. In this example implementation, the comment included in the private message can provide encouragement and/or supports the sender's selection of the gift item for the recipient. Therefore, Block S140 can further filter third-party user comments and include only a selection of the most supportive comments to encourage the sender to fulfill the gift transactions. In this example implementation, the private message can be static, wherein the message to the sender includes only one or more comments posted to the notification prior to generation of the private message for the sender. Alternatively, the message can be dynamic, wherein the message is updated with additional comments, posted by third-party users and pertaining to the notification, until the sender submits or confirms payment for the gift item. Furthermore, in this example implementation, Block S140 can delay transmission of the private message to the sender until a predefined number of comments, pertaining to the gift order, are posted to the social network by third-party users. For example, Block S140 can delay transmission of the private message to the recipient until three comments are posted to social network in response to the notification of the gift order, wherein Block S140 identifies the most encouraging of the first three comments, generates a static private message including the most encouraging comments, and transmits the static private message to the sender. However, Block S140 can generate the private message that includes a link or pointer to one or more third-party user comments, notifies the sender of the number of comments posted to the published notification of the gift order, or includes any other relevant information, encouragement, or social pressure for the sender.

In a variation of the method S100, such as the third mechanism, Block 140 recites initiating payment of the second gift item by the second sender in response to approval of the aggregated gift item by the recipient. For the first gift item that is aggregated with the second gift item in the fourth mechanism, Block S140 can similarly initiate payment of the first gift item by the first sender.

Alternatively, Block S140 can source sender payment information entered into the gift request by the sender, such as shown in FIG. 6G. In this alternative, Block S140 can push a private message to the sender to inform the sender that the recipient approved the gift, that the gift will be delivered to the recipient, and that the senders billing account will be charged for the gift item.

Once a suitable payment method is supplied by the sender and the gift item has been approved by the recipient, Block S140 can complete the gift transaction by initiating transfer of a monetary payment from a financial account of the sender to a financial account linked to a merchant supplying the gift item. Similarly, when the recipient exchanges the gift item for a charitable donation, Block S140 can include transferring funds, of a value up to the set price of the gift item specified by the recipient, from a financial account linked to the sender to a financial account linked to the charity. For the gift item that is a tangible gift item to be shipped to the recipient, Block S140 can further initiate transfer of funds to a shipping company to pay for physical delivery of the gift item to the recipient. However, Block S140 can distribute funds to any suitable merchant, retailer, shipper, item delivery venue, third-party entity, computer system host, etc. in response to approval of the gift item by the recipient.

As in the fourth mechanism and shown in FIGS. 4A and 4B, in one variation of the method S100, Block 140 recites, in response to approval of the modified order for the gift item by the recipient, completing purchase of the modified gift item by initiating payment from the sender according to modifications made to the order for the gift item up to the set price specified in the gift request. In this variation, Block S140 can include completing purchase of the second gift item by charging a financial, account linked to the sender, up to the set price of the gift item specified in the gift request. For example, if the recipient chooses to downgrade a gifted tablet from a 64 GB model to a less expensive 32 GB model, Block S140 can initiate a credit card charge to the sender that is less than initially specified by the sender for the 64 GB model. Alternatively, in another example, if the recipient chooses to upgrade a gifted tablet from a 32 GB model to a more expensive 64 GB model, Block S140 can initiate a credit card charge to the sender that is up to the price of the 32 GB model initially selected by the sender, and Block S140 can further prompt the recipient to supply payment for the difference. However, Block S140 can function in any other way to trigger payment for and/or compete purchase of the gift item by the sender in response to approval of the gift item by the recipient

As shown in FIGS. 1B, 2B, 3B, and 4B, a variation of the method S100 includes Block S180, which recites initiating transfer of the gift item to the recipient in response to approval of the gift item by the recipient and payment for the gift item by the sender. As in the third mechanism, Block S180 can similarly include initiating transfer of the aggregated gift item to the recipient. In the implementation of the method S100 in which the gift item is an electronic good, Block S180 can initiate delivery of the gift item through the recipient-side interface. Alternatively, Block S180 can initiate delivery of the gift item through an email, SMS text message, on online gaming site, an online social network (e.g., a social networking profile of the recipient), or through any other suitable venue. Alternatively, Block S180 can deliver an access key to the recipient, such as via email, SMS text message, an inter-social network message, etc., wherein the recipient can enter the access key to receive the electronic good. Generally, the gift item that is an electronic good, the gift item can be accessible by the recipient through an electronic device, such as a smartphone, a tablet, or a laptop computer.

In the implementation in which the gift item is a tangible good, Block S180 can initiate delivery of the gift item through a shipping or delivery service. Generally, Block S180 can initiate shipment of the gift item that is a tangible good to a physical address associated with the recipient in response to completion of payment for the gift item by the sender. For example and as described above, Block S140 can transfer a portion of funds allocated by the sender for the gift to a shipping company to pay for delivery of the item to the recipient, and Block S180 can function to transmit relevant shipping information to the shipping company, such as package weight and content, drop-off date and location, and address of final destination. In one implementation, Block S180 sources a delivery address from the gift request in which the sender specifies the address of the recipient. In another implementation, Block S120 includes prompting the recipient to enter a delivery address within the private message to the recipient, as shown in FIG. 7B. Alternatively, Block S180 can deliver an electronic allocation certificate that the recipient can exchange at a brick-and-mortar store for the gift item sent by the sender. Similarly, Block S180 can electronically deliver an access code to the recipient, such as via email, SMS text message, an inter-social network message, etc., wherein the recipient can enter the access code, shipping information, etc. within an online merchant checkout service to finalize the order for the gift item. However, Block S180 can function in any other suitable way to initiate delivery of the gift item to the recipient.

As shown in FIGS. 4A and 4B, one variation of the method S100, including the fourth mechanism, includes Block S150, which recites modifying the initial gift order according to a customization input from the recipient. Generally, the gift order can specify details of the gift item, such as a size, color, technical specifications, engravings, redemption date, time, and/or location, etc., any of which can be modified by the recipient to better suit the needs and/or wants of the recipient. Block S150 can therefore enable flexibility in the gift order such that, once adjusted by the recipient, the gift item can substantially satisfy the recipient even though the sender did not fully grasp the tastes or even interests of the recipient when entering the gift order.

Therefore, the method S100 can prompt the recipient to modify the gift item, such as through Block S120, and Block S150 can adjust an order for the gift item to suit. For example and as described above, the recipient can exchange the gift item for a second gift item, exchange the gift item for a charitable donation, personalize the gift (e.g., specify a personal engraving), customize the gift (select a particular color or color combination), modify a technical specification of the gift (e.g., upgrade hard drive memory), modify a size of the gift item (e.g., select a proper shirt size), modifying a deliver time for the gift item (e.g., reservation date and time for a gift item that is dinner at a fine restaurant), or modify a delivery method of the gift (e.g., pickup or delivery), though the method S100 can enable the recipient to modify the gift order in any other way. Generally, Block S150 can receive recipient modifications to the gift item from the sender and adjusts the gift order according to the adjustments entered by the recipient, Block S120 confirms recipient approval of the modified gift item, and Block S140 initiates fulfillment of the adjusted gift order.

Furthermore, Block S150 can modify the initial gift order set by the sender or the modified gift order set by the recipient according to a comment generated by the third-party user and posted to the published notification. Therefore, Block S150 can enable community customization of the gift order for the sender. The method S100 can additionally or alternatively direct the recipient from the private message of the recipient to a recipient-side interface configured to receive recipient preferences, wherein Block S150 indirectly updates or modifies the gift order according to recipient preferences. However, Block S150 can function in any other way to modify the gift order according to a customization input from the recipient, a third-party user, or any other suitable entity.

As shown in FIGS. 5A and 5B, one variation of the method S100, including the fifth mechanism, includes Block S152, which recites tracking approval and modification of the gift item by the recipient. Block S152 can further include tracking approvals and modifications of gift items by other recipients. Generally, Block S152 can identify inputs, from each recipient, that customize a respective gift item, personalize the gift item, exchange the gift item for an alternative gift item, adjust a specification of the gift item, specify details of user or delivery, etc. Block S152 can therefore collect gift-related data for multiple gifts sent to each of a multitude of recipient, by multiple senders, over time. This gift-related data can be suggestive of the tastes, interests, preferences, needs, etc. of a recipient, such as indicated by recipient inputs that modify the gift item.

However, Block S152 can additionally or alternatively collect gift-related data suggestive of tastes, interests, preferences, needs, etc. of a sender, such as indicated by gift item selection by the sender. Furthermore, Block S152 can collect recipient- and/or sender-related information, such as age, sex, race, gender, location, income level, marital status, or other demographic information of a recipient and/or sender, a relationship status between a sender and recipient, sender and/or recipient interests or hobbies, or current sender and/or recipient state that is indicative of an inherent need. Therefore, Block S152 can collect data from the gift request, from an online social networking or other profile of a recipient or sender, from a financial account of a sender or recipient including purchase history, or from any other suitable source.

Data collected in Block S152 can be collected and stored on a remote server in communication with the computer system such that the data is accessible to the computer network to generate the trend report in Block S160.

As shown in FIGS. 5A and 5B, one variation of the method S100 further includes Block 160, which recites generating a trend report of gift customization based upon a characteristic of recipients who modify and accept gift items specified by respective senders. Block S160 can function to aggregate sender and/or recipient data collected in Block S150 and to isolate trends in the data across multiple senders and/or recipients based upon one or more particular characteristics of a group of senders and/or recipients. Similar to Block S118, Block S160 can therefore include extracting a characteristic of gift recipients from social networking profiles of the recipients according to privacy settings set by recipients. In one implementation, Block S160 can include extracting relationship statuses between senders and respective recipients from social networking profiles of the recipients and correlating trends in modifications of gift items with extracted relationship statuses. This implementation can enable Block S160 to isolate one or more trends in recipient modifications of gift items according to relationship statuses between senders and respective recipients. In another implementation, Block S160 can include extracting gender and age data of recipients from social networking profiles of the recipients, wherein generating the trend report of gift customization comprises correlating trends in modifications of gift items with gender and age of recipients. This implementation can enable Block S160 to isolate one or more trends in recipient modifications of gift items according to modifications of gift items according to recipient age and/or gender.

Block S160 can also include correlating a characteristic of certain recipients with a particular type or category of gift item selected by respective senders, a form of personalization of a gift item, or a common exchange of a gift item of one type for a gift item of another type, or any other gift order modification trend amongst recipients. Furthermore, Block S160 can generate multiple trend reports of gift customization, wherein each trend report is correlated with a particular or unique recipient demographic or other recipient characteristic. However, Block S160 can function in any other way to correlate a trend in recipient modification and/or approval of gift order with a recipient characteristic to generate one or more trend reports.

As shown in FIG. 5B, the method S100 can implement the trends report(s) to generate subsequent recommendations, for subsequent senders, of gift items for subsequent recipients, such as by feeding the trend report(s) of Block S160 into Block S170 for a subsequent sender. For example, Block 170 can generate, for a subsequent sender, a list of suggested gift items for a subsequent recipient based upon a correlation between a characteristic of the subsequent recipient and a trend report output from Block S160. In this example, Block S170 can access a characteristic of the subsequent recipient, such as based upon privacy settings set by the subsequent recipient, to select a suitable or relevant trend report to inform generation of the list of recommended gift items for the subsequent recipient. In this example, Block 152 can further include tracking approval and modification of the subsequent gift item by the subsequent recipient, and Block S160 can further augment the trend report with approval and/or modification of the subsequent gift item by the subsequent recipient.

The methods and mechanisms of the embodiment can be embodied and/or implemented at least in part as a machine configured to receive a computer-readable medium storing computer-readable instructions. The instructions can be executed by computer-executable components integrated with a computer system, application, applet, host, server, network, website, communication service, communication interface, hardware/firmware/software elements of a user computer, or mobile device, or any suitable combination thereof. Other systems and methods of the embodiments can be embodied and/or implemented at least in part as a machine configured to receive a computer-readable medium storing computer-readable instructions. The instructions can be executed by computer-executable components integrated by computer-executable components integrated with apparatuses and networks of the types described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

We claim:

1. A method comprising:
accessing a list of gift items previously selected for a recipient by previous senders, the list comprising a first gift item previously selected by a first sender;
receiving a gift request from a second sender, the gift request specifying the recipient and a second gift item;
identifying a complementary relationship between the first gift item and the second gift item;
requesting approval, from the recipient, of an aggregated gift item that is a combination of the first gift item and the second gift item;
posting a notification of the aggregated gift item for publication by an online social network in response to approval of the aggregated gift item by the recipient; and
initiating payment of the second gift item by the second sender in response to approval of the aggregated gift item by the recipient.

2. The method of claim 1, further comprising recommending the second gift to the second user based upon identification of the complementary relationship between the first gift item and the second gift item.

3. The method of claim 1, further comprising prompting the second sender to confirm aggregation of the first gift item with the second gift item.

4. The method of claim 1, further comprising initiating transfer of the aggregated gift item to the recipient in response to approval of the aggregated gift item by the recipient and payment for the gift item by the sender.

5. The method of claim 1, wherein identifying the complementary relationship between the first gift item and the second gift item comprises identifying a complementary use scenario for the first gift item and the second gift item.

6. The method of claim 1, wherein requesting approval of the aggregated gift item comprises pushing a private message of the gift item to the recipient through the online social network, the private message prompting the user to approve the second gift item in combination with the first gift item that was previously approved by the recipient.

7. The method of claim 1, wherein initiating payment for the second gift comprises transmitting a private message to the sender, wherein the private message notifies the sender of recipient approval of the aggregated gift item and prompts the sender to enter personal credit card information to complete payment of the second gift item.

8. The method of claim 1, further comprising updating the notification published by the online social network with a comment generated by a third-party user, the comment pertaining to the aggregated gift item.

9. The method of claim 8, wherein initiating payment for the second gift comprises transmitting a private message to the sender, wherein the private message comprises the comment generated by the third-party user.
